(19) United States
(12) Patent Application Publication
(10) Pub. No.: US 2008/0019357 A1
(43) Pub. Date: Jan. 24, 2008

(54) Apparatus and Method for Determining Device Presence and Type

(75) Inventors: Armando Jaime Martinez, Austin, TX (US); Paul Fuller, Carrollton, TX (US)

Correspondence Address: ANDREA E. TRAN;PRAMUDJI WENDT & TRAN, LLP, 1800 BERING DRIVE, SUITE 540, HOUSTON, TX, 77057, US

(73) Assignee: Dell Products L.P., Round Rock, TX (US)

(21) Appl. No.: 11/458,940

(22) Filed: Jul. 20, 2006

(51) Int. Cl. H04L 12/50

(52) U.S. Cl. 370/368

(57) ABSTRACT

An apparatus and method for determining if an interface connector is coupled to a device of a first type, a device of a second type, or to a device of a third type or no device.

### BACKGROUND

1. Technical Field

The present disclosure generally relates to apparatus, methods and products in the field of information handling systems.

2. Background Information

As the value and use of information continues to increase, individuals and businesses seek additional ways to process and store information. One option available to users is an information handling system (“IHS”). An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

The following presents a general summary of some of the many possible embodiments of this disclosure in order to provide a basic understanding of this disclosure. This summary is not an extensive overview of all embodiments of this disclosure. This summary is not intended to identify key or critical elements of the disclosure or to delineate or otherwise limit the scope of the claims. The following summary merely presents some concepts of the disclosure in a general form as a prelude to the more detailed description that follows.

According to one embodiment, there is provided an apparatus comprising a device detector that produces a multi-state signal having three or more states identifying a first device when the first device is in data communication with the device detector, the states including a first state identifying a device of a first interface type, a second state identifying a device of a second interface type, and a third state identifying either a no device present condition or a device of a third interface type, the multi-state signal being transmittable to an information handling system processing component.

According to another embodiment of the present disclosure, there is provided a method which includes generating indicator data with a circuit in data communication with a first interface having a first device coupled thereto, the indicator data including first data when the first interface is coupled to a device of a first interface type, second data when the first interface is coupled to a device of a second interface type, and third data when the first interface is not coupled to either a device of a first interface type or a device of a second interface type.

According to even another embodiment, there is provided an information handling system comprising an interface connector and a device detector in data communication with the interface that produces a multi-state signal having three or more states identifying a first device when the first device is in data communication with the interface connector, the states including a first state identifying a device of a first interface type, a second state identifying a device of a second interface type, and a third state identifying either no device present or a device of a third interface type, the multi-state signal being transmittable to an information handling system processing component.

### BRIEF DESCRIPTION OF THE DRAWINGS

The following drawings illustrate some of the many possible embodiments of this disclosure in order to provide a basic understanding of this disclosure. These drawings do not provided an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed descriptions taken in conjunction with the accompanying drawings in which like elements have been given like numerals.

FIG. 1 is a schematic of a non-limiting example of information handling system 5 which may include central processing unit (CPU) 15 in data communication over bus 40 with fixed data storage 25 and memory 20.

FIG. 2 is a schematic representation of common connector 21 which may suitably connect with either a first plug type 11 or a second plug type 12.

FIG. 3 is a block diagram illustrating a non-limiting example of a device 300, having connector 301 and detector circuit 334.

FIG. 4 is a block diagram of a non-limiting example of SAS device 400, including interface 401, having ports 402 and 404.

FIG. 5 is a block diagram of non-limiting examples of SATA device 500, including its interface connector 501 having a port 502.

FIG. 6 is a block diagram of a non-limiting embodiment of a method 600, which may include generating step 601 and may include operating step 602.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size; shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit communications between the various hardware components.

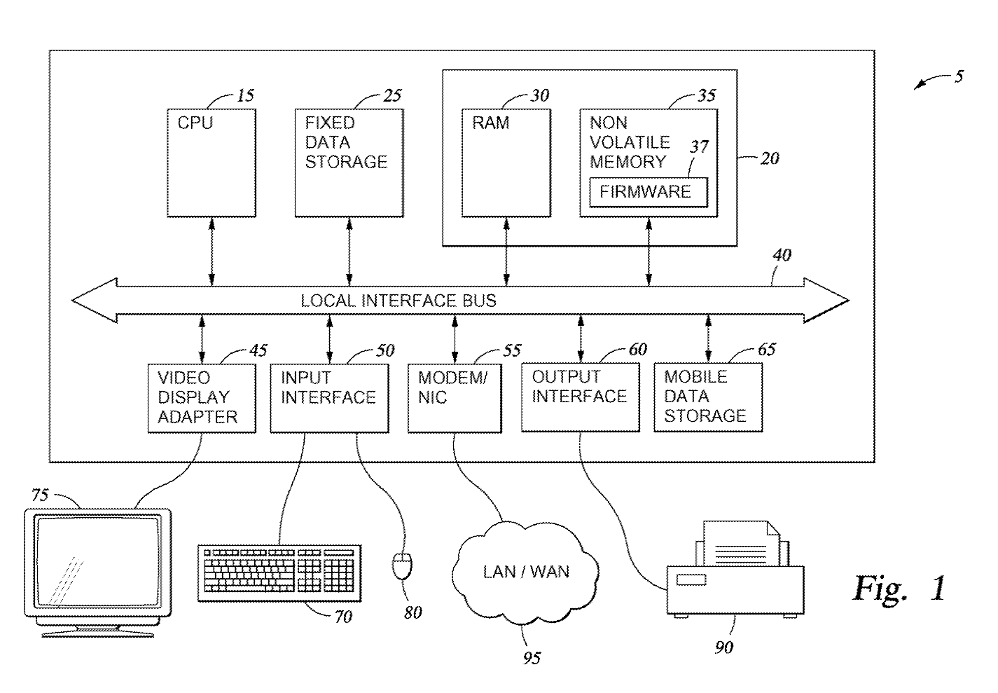

Referring to FIG. 1, in a non-limiting example, information handling system 5; according to one aspect, comprises central processing unit (CPU) 15 in data communication over bus 40 with fixed data storage 25 and memory 20. Memory 20 comprises non-volatile memory 35 having a firmware program 37; such as BIOS, stored therein. Non-volatile memory includes, but is not limited to, flash memory, and electrically erasable programmable read-only memory (EEPROM). The firmware 37 may contain, for example, all the programming code required to control the keyboard 70, display monitor 75; mouse 80, mobile data storage 65, other input/output devices, and a number of miscellaneous functions. Memory 20 also comprises dynamic memory 30 that may be RAM. The OS and application programs are commonly loaded into dynamic memory 20 for execution. Data in dynamic memory 20 is typically lost when power is removed.

Fixed data storage 25 commonly stores the OS, application programs, and other data for use by IHS 5. Fixed data storage refers to permanent (non-volatile) storage. Fixed data storage devices include but are not limited to: a hard disk drive, and a magnetic tape drive. An array of hard disk drives may be controlled by a disk array controller and may be part of a storage server. In addition, mobile data storage device 65 may interface with bus 40 for transferring data to or from IHS 5. Examples of mobile data storage include, but are not limited to: an external portable hard drive; a solid state semiconductor storage device, such as flash memory; and an optical disc storage device, such as CD and DVD. IHS 5 may further comprise a video display adapter 45, a plurality of input interfaces 50, a modem/network interface card (NIC) 55, a plurality of output interfaces 60, and a mobile data storage device 65, all of which may also be coupled to the local interface 40. Output interface 60 may transmit hard copy data to printer 90.

IHS 5 may be coupled to an external network 95 through NIC 55 thus allowing the IHS 5 to send and receive data via the external network 95 to remote device. As shown, the external network 95 may be a local area network (LAN), a wide area network (WAN), or other similar network. As described in FIG. 1, IHS 5 may act as a personal computer, a network storage device, a network server, or any other enabled information handling device.

An interface may be utilized for making hardware and data connections between any combination and number of devices, non-limiting examples of devices include IHS's, and components and peripherals therefor, and any combinations thereof. An interface connector refers to one of the pair of mating connectors that comprises an interface. The pair of connectors is sometimes referred to as a receptacle and plug, or female and male connectors, respectively.

There exist in the IHS industry a number of interface standards for making connections between any combination and number of devices, non-limiting examples of which include IHS's, components and peripherals therefor. As a non-limiting example, there exists the Advanced Technology Attachment (ATA) standard and the Small Computer System Interface (SCSI) standard. These standards define both the physical interface and the protocol used to communicate over the physical interface. Both standards have evolved over time through the release of new ATA and SCSI specifications, specifically, the Serial ATA (SATA) specification and the Serial Attached SCSI (SAS) specification. As used throughout this disclosure, reference to ATA, SCSI, SATA and SAS is intended to encompass all versions and releases of the associated specifications.

Physical and electrical interfaces may be configured that comply with both SATA and SAS standards. A common interface connector as used herein is one that can suitably interface with a corresponding mating connector of a different interface standard. A non-limiting example of a common interface connector would be a connector that can interface with at least both a SAS compliant interface connector and a SATA compliant interface connector. Ideally, a device connected through a common interface connector would operate identically whether connected with one standard of interface or another standard of interface. However, this disclosure also contemplates that a device might operate differently when connected through a common interface with a first type of plug as opposed to a second type of plug. As a non-limiting example, this disclosure contemplates that a device might operate the same or differently when connected to a SAS receptacle with a SAS plug as opposed to a SATA plug.

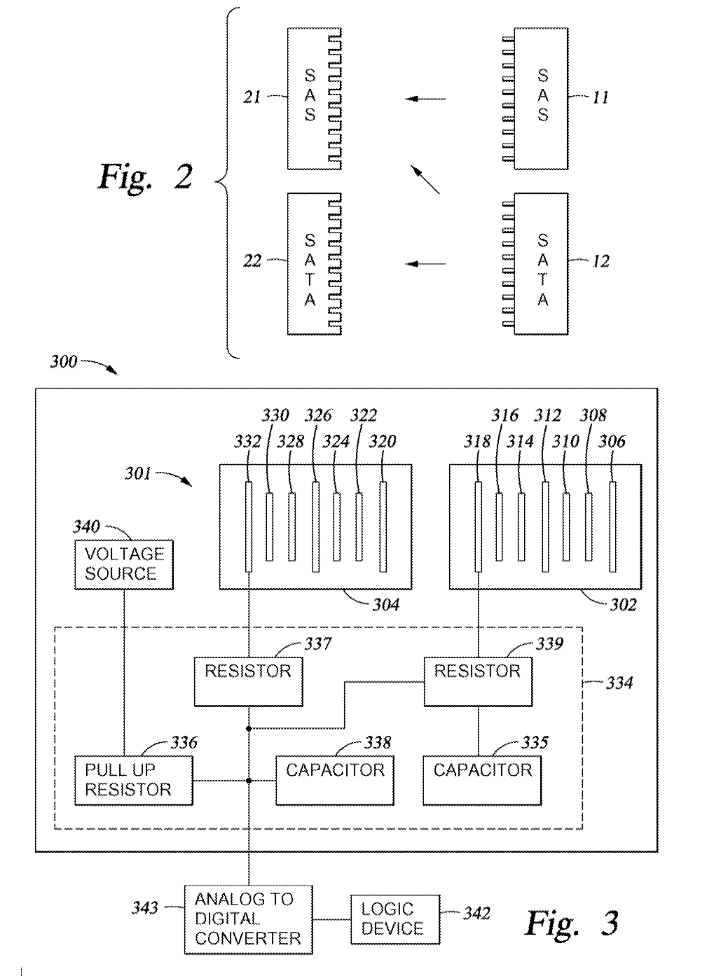

FIG. 2 is a schematic representation of a non-limiting example of a common interface connector 21, which may suitably connect with either a first plug type 11 or a second plug type 12.

While common interface connector 21 does not have to be so limited, as shown in FIG. 2, common interface connector 21 comprises a SAS receptacle, as current SAS configuration standards allow a SAS receptacle to accommodate both SAS and SATA plugs. In contrast, a SAS compliant plug may not connect to a receptacle configured according to current SATA configuration standards. As shown in FIG. 2, interface connector 22 may comprise a SATA receptacle. The present disclosure is not limited by the current version of interface standards discussed herein for illustration, and changes to SATA configuration standards may result in a SATA receptacle accepting both SATA and SAS plugs. Such a receptacle is considered within the scope of the disclosure and contemplated by the term common interface connector as used herein,

It should be understood that when connecting a first device together with a second device, whether the interface receptacle is on the first or second device, and the whether the corresponding mating interface plug is on the other device, generally is not a factor is determining operation or performance. Thus, in the absence of any industry standard or convention, it is matter of personal choice as to which device is provided with the interface receptacle and which is provided with the corresponding mating interface plug. As a non-limiting example, it is not uncommon commercially to find hard drives equipped with an interface plug and hard drive controllers equipped with the corresponding mating interface receptacle. Of course, this disclosure is not to be read as assigning an interface receptacle and an interface plug to any particular device, but rather is to be read as contemplating any combination.

As used herein, “device of ‘X’ interface type,” means a device which interfaces using interface standard “X.” As used herein, a SAS device refers to any device equipped with a SAS interface connector. Likewise, a SATA device refers to any device equipped with a SATA interface connector.

There are a number of reasons to determine the standard of the device connected to a common connector, non-limiting examples of which include to communicate with the device using the proper protocol and to determine if the device has the desired standard.

This disclosure provides non-limiting examples of methods and apparatus for determining if a device connected to a SAS receptacle is (1) a SAS device, (2) a SATA device, or (3) neither a SAS device nor a SATA device and for determining whether a device is present.

FIG. 3 is a block diagram of a non-limiting example of a device 300, having connector 301 and detector circuit 334. While device 300 can be any IHS, IHS component or IHS peripheral, a non-limiting example of which includes IHS 5, in the non-limiting embodiment as shown in FIG. 3, device 300 comprises a backplane with any number of connectors 301 each which may paired with detector circuits 334.

Although Interface connector 301 will be described with particularity, it should be understood that the description is meant to be that of a non-limiting SAS connector embodiment as shown in FIG, 3, and that other embodiments of any present or future contemplated interface standard may be configured as desired having any suitable number and arrangement of ports, transmit (“TX”) wires (i.e., “pins”), receive wires (“RX”), and ground wires (“GND”).

The non-limiting embodiment of FIG. 3 shows interface connector 301 which may have a first port 302 and second port 304, and that each port may include one or more transmit (“TX”) wires (e.g., “pins”), receive (“RX”) wires, and ground (“GND”) wires. FIG. 3 also shows that port 302 may include GND pins 306, 312, and 318, TX pins 308 and 310, and RX pins 314 and 316, and shows that port 304 may include GND pins 320, 326, and 332, TX pins 322 and 324, and RX pins 328 and 330, with all pins arranged as shown. Interface connector 301 may include a power port (not shown), which in the non-limiting example for SAS and SATA connectors may include a 15 pin power section.

A device detector may be in communication with interface connector 301 and may produce at least three data states indicative of the interface type of any device coupled to the interface connector. As a non-limiting example, the device detector may comprise a detection circuit, a non-limiting example of which includes detection circuit 334. In the non-limiting embodiment as shown, detection circuit 334 may be coupled to any one or more of the ground pins of port 302 and to any one of the ground pins of port 304, and detects whether coupled to interface 301 is (1) a SAS device, (2) a SATA device or (3) neither a SAS device nor a SATA device or no device present. It should be understood that a detection circuit may be utilized that would detect whether coupled to interface 301 is (1) a SAS device, (2) a SATA device, (3) a device that is neither a SAS device, or (4) no device present. In the non-limiting embodiment as shown in FIG. 2, detection circuit is coupled to port 302 GND pin 318 and to port 304 GND pin 332. It should be understood that part or all of detection circuit 334 may be components of device 300 and/or interface 301.

Detection circuit 334 may be any circuit capable of producing indicator data indicative of three or more different states, one state each associated with a connection to (1) a SAS device, (2) a SATA device, or (3) neither a SAS device nor a SATA device or no device. Non-limiting examples of types of indicator data include any that can be utilized to communicate device type, non-limiting examples of which include voltage, impedance, resistance, amperage, capacitance, vibration, sound, sound train, light, light train, any suitable analog output or signal, any suitable digital output or signal, and the like.

As a non-limiting example, detection circuit 334 may be any circuit capable of producing three or more different voltage levels or states, one unique voltage level each associated with a connection to (1) a SAS device, (2) a SATA device, or (3) a device that is neither a SAS device nor a SATA device or no device. The A to D converter 343 translates the several voltage levels into several digital states for use by a processor or CPLD in determining the type of device connected via the interface. The voltage levels are not necessarily precise voltage levels and the term voltage level includes a range of voltages, which may be distinguished from other levels and ranges.

In the non-limiting embodiment as shown in FIG. 3, detection circuit 334 may include a resistor (e.g., a “pull-up” resistor) 336 in series with a pair of parallel resistors 337 and 339, each of the three resistors having a resistance of approximately 4.7 kohm. It should be understood that these resistors may be replaced by any number, combination, and arrangement of resisters of any suitable resistance value, provided that three or more different voltage levels or states will be produced based on connection to (1) a SAS device, (2) a SATA device, or (3) neither a SAS device nor a SATA device or no device.

As shown, detection circuit 334 may also include capacitors 335 and 338, each of approximately 1 uF. Any suitable number and type of capacitors may be utilized and may be selected to ensure a low impedance AC current return path to the GND pins. Accordingly, capacitor 335 and capacitor 338 reduce the adverse effect of detection circuit 334 on signal clarity of the interface 301.

Detection circuit 334 is coupled to a voltage source 340 via the pull up resistor 336. While any suitable voltage source and voltage level may be utilized, in the non-limiting embodiment of FIG. 3, voltage supplied by the voltage source 340 is approximately 5 volts.

In another aspect, detection circuit 334 may be coupled to a logic device 342 (e.g., a processor or a complex programmable logic device (“CPLD”), a field programmable gate array (“FPGA”) or a comparator circuit) for use in determining the device presence and/or type.

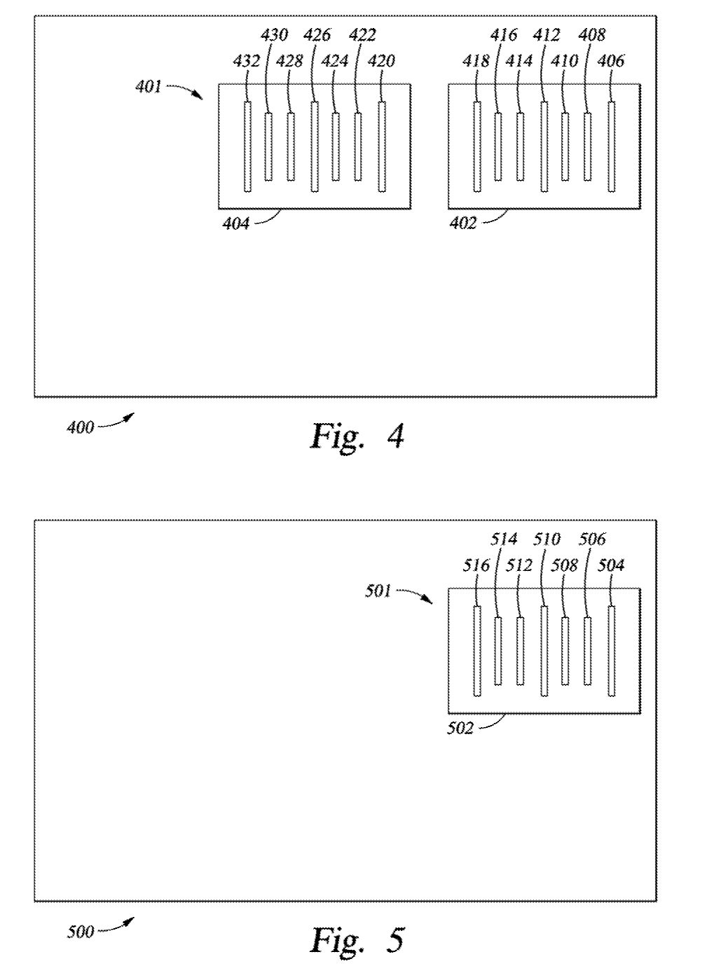

FIG. 4 is a block diagram of a non-limiting example of SAS device 400, including interface connector 401, having ports 402 and 404. While device 400 can be any IHS, IHS component or IHS peripheral, a non-limiting example of which includes IHS 5, in the non-limiting embodiment as shown in FIG. 4, device 400 comprises a SAS data storage device having SAS interface connector 401.

The interface connector 401 of FIG. 4 is capable of being coupled to interface 300 of FIG. 3. More specifically, storage device 400 includes a first port 402 and a second port 404, each of which is respectively capable of being coupled to the port 302 and the port 304 of FIG. 3.

Although interface connector 401 will be described with particularity, it should be understood that the description is meant to be that of a non-limiting SAS connector embodiment as shown in FIG. 4, and that other embodiments of any present or future contemplated interface standard may be configured as desired having any suitable number and arrangement of ports, transmit (“TX”) wires (i.e., “pins”), receive wires (“RX”), and ground wires (“GND”).

The non-limiting embodiment of FIG. 4 shows interface connector 401 which may have a first port 402 and second port 404, and that each port may include one or more transmit (“TX”) wires (e.g., “pins”), receive (“RX”) wires, and ground (“GND”) wires. For example, the port 402 may include GND pins 406, 412, and 418, TX pins 408 and 410, and RX pins 414 and 416, arranged as shown. Port 404 may include GND pins 420, 426, and 432, TX pins 422 and 424, and RX pins 428 and 430, arranged as shown. Interface connector 401 may include a power port (not shown), which in the non-limiting example for SAS and SATA connectors may include a 15 pin power section.

FIG. 5 is a block diagram of a SATA device 500, including an interface connector 501 having a port 502. While device 500 can be any IHS, IHS component or IHS peripheral, a non-limiting example of which includes IHS 5, in the non-limiting embodiment as shown in FIG. 5, device 500 comprises a SATA data storage device 500 having SATA interface connector 501.

Similar to the SAS storage device 400, the SATA storage device 500 is capable of being coupled to interface 300 of FIG. 3. However, the SATA storage device 500 couples to the interface 300 via one of the ports 302 and 304. In the non-limiting embodiment as shown, SATA storage device 500 couples to the interface 300 via the port 302. Accordingly, SATA storage device 500 includes a port 502, which is capable of being coupled to the port 302 of FIG. 3.

Although Interface connector 501 will be described with particularity, it should be understood that the description is meant to be that of a non-limiting SATA connector embodiment as shown in FIG. 5, and that other embodiments of any present or future contemplated interface standard may be configured as desired having any suitable number and arrangement of ports, transmit (“TX”) wires (i.e., “pins”), receive wires (“RX”), and ground wires (“GND”).

The non-limiting embodiment of FIG. 5 shows interface connector 501 which may have a port 502, and this port may include one or more transmit (“TX”) wires (e.g., “pins”), receive (“RX”) wires, and ground (“GND”) wires. Similar to the port 402 of FIG. 4, the port 502 includes GND pins 504, 510, and 516, TX pins 506 and 508, and RX pins 512 and 514, arranged as shown. Interface connector 501 may include a power port (not shown), which in the non-limiting example for SAS and SATA connectors may include a 15 pin power section.

As discussed above, the detection circuit 334 determines (e.g., detects) whether a SAS storage device a SATA storage device, or whether neither a SAS nor SATA or no device, is coupled to the interface 301.

A non-limiting method embodiment of this disclosure includes any or all of determining a device's interface type and generating indicator data based thereon. The discussion above as it relates to interface type and indicator data is applicable here.

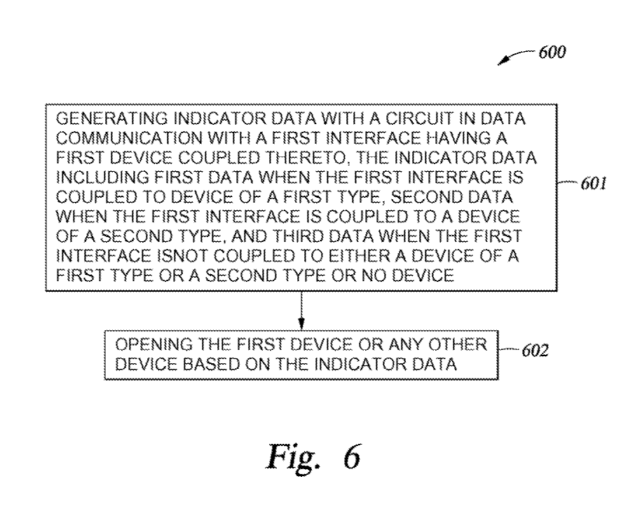

FIG. 6 is a block diagram of a non-limiting embodiment of a method 600, which may include generating step 601 and may include operating step 602. Generating step 601 may include generating indicator data with a circuit in data communication with a first interface having a first device coupled thereto, the indicator data including first data when the first interface is coupled to a device of a first interface types second data when the first interface is coupled to a device of a second interface type, and third data when the first interface is not coupled to either a device of a first interface type or a device of a second interface type. Once the device interface type is determined this knowledge may be utilized to operate the device, or any other device.

In a “SAS” solution of detection circuit 334, if SAS device 400 is coupled with SAS device 300, the respective pins on connectors 301 and 401 will connect. Resistor 337 is connected to GND pin 332, which is in turn connected to GND pin 432, and resistor 339 is connected to GND pin 318, which is in turn connected to GND pin 418. The 5V is therefore dropped across pull-up resistor 336 in series with parallel resistors 337 and 339, indicating a first data or a first voltage of 1.67V at converter 343.

In a “SATA” solution of detection circuit 334, if SATA device 500 is coupled with SAS device 300, the respective pins on connectors 301 and 501 will connect. Resistor 339 is connected to GND pin 318, which is in turn connected to GND pin 516. Since port 304 of connector 301 has no counterpart port on connector 501, resistor 337 is connected to GND pin 332, which is not connected to any counterpart on connector 501. Thus, the 5V is dropped across pull-up resistor 336 in series with only resister 339, indicating a second data or a second voltage of 2.5V at converter 343.

In a “no device present” solution of detection circuit 334, if no device is coupled with SAS device 300, there are no respective pins to connect with the pins of connector 301. Both resistor 337 and resister 339 are not grounded. Thus, the 5V is dropped only across pull-up resistor 336, indicating a third data or a third voltage of 5V at converter 343.

It is also possible that a device connected is neither a SAS nor SATA device. In a “neither SAS nor SATA” solution of detection circuit 334, if such a device is coupled with SAS device 300, and there are no respective pins to connect with the pins of connector 301, then both resistor 337 and resister 339 are not grounded. Thus, the 5V is dropped only across pull-up resistor 336, indicating a third data or a third voltage of 5V at converter 343.

The present disclosure also provides a computer-receivable media carrying a multi-state signal, the multi-state signal having three or more states, the states including a first state identifying a device of a first type, a second state identifying a device of a second type, and a third state identifying a device of a third type, the multi-state signal being transmittable to an information handling system processor,

The present disclosure is to be taken as illustrative rather than as limiting the scope or nature of the claims below While specific embodiments have been discussed herein, it should be understood that other embodiments, numerous modifications, and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Such other embodiments, modifications, and variations are to be considered within the scope of the claims below.

Given the above disclosure of general concepts and specific embodiments, the scope of protection sought is to be defined by the claims appended hereto The issued claims are not to be taken as limiting Applicant's right to claim disclosed, but not yet literally claimed subject matter by way of one or more further applications including those filed pursuant to the laws of the United States and/or international treaty,

What is claimed is:

1. An apparatus comprising:
a device detector that produces a multi-state signal having three or more states identifying a first device when the first device is in data communication with the device detectors the states including a first state identifying a device of a first interface type, a second state identifying a device of a second interface type and a third state identifying either no a device present condition or a device of a third interface type, the multi-state signal being transmittable to an information handling system processing component.

2. The apparatus of claim 1, wherein the detector further comprises a second device that interfaces with the first device providing data communication between the first device and the device detector.

3. The apparatus of claim 1, wherein the states identify a device selected from the group consisting of SAS devices and SATA devices.

4. The apparatus of claim 1, wherein the multi-state signal comprises a one unique voltage for each state.

5. The apparatus of claim 1, wherein the multi-state signal comprises a unique binary state for each state.

6. The apparatus of claim 1, wherein the device detector comprises a detection circuit.

7. The apparatus of claim 6, wherein the detection circuit comprises a plurality of resistive elements.

8. The apparatus of claim 1, wherein the device detector comprises:
a circuit wherein the first interface type comprises a serial attached small computer systems interface type, wherein the second interface type comprises a serial attached advanced technology attachment interface type, wherein the first state is a first voltage, wherein the second state is a second voltage, wherein the third state is a third voltage, and wherein the first voltage, the second voltage and the third voltage are all different.

9. The apparatus of claim 8, wherein the device detector further comprises a serial attached small computer systems interface providing data communication between the first device and the device detector.

10. A method comprising:
generating indicator data with a circuit in data communication with a first interface having a first device coupled thereto, the indicator data including first data when the first interface is coupled to a device of a first interface type, second data when the first interface is coupled to a device of a second interface type, and third data when the first interface is not coupled to either a device of a first interface type or a device of a second interface type.

11. The method of claim 10, wherein the first interface comprises a serial attached small computer systems interface.

12. The method of claim 11, wherein the device of a first interface type comprises:
a serial attached small computer systems interface data storage device; and
the device of a second interface type comprises a serial attached advanced technology attachment interface data storage device.

13. The method of claim 10, wherein the first data is indicative of when the first interface is attached to a serial attached small computer systems interface device, and the second data is indicative of when the first interface is attached to a serial attached advanced technology attachment interface device.

14. The method of claim 10, further comprising operating the first device based on the indicator data.

15. An information handling system comprising:
an interface connector, and
a device detector in data communication with the interface that produces a multi-state signal having three or more states identifying a first device when the first device is in data communication with the interface connector, the states including a first state identifying a device of a first interface type, a second state identifying a device of a second interface type, and a third state identifying either no device present or a device of a third interface type, the multi-state signal being transmittable to an information handling system processing component.

16. The apparatus of claim 15, wherein the device of a first interface type is a SAS device and the device of a second interface type is a SATA device.

17. The apparatus of claim 15, wherein the interface is a SAS interface, the device of a first interface type is a SAS storage device, and the device of a second interface type is a SATA storage device.

18. The apparatus of claim 17, wherein the multi-state signal comprises a first voltage level a second voltage level and a third voltage level.

19. The apparatus of claim 15, wherein the interface comprises a backplane connector.

20. The apparatus of claim 15, wherein the processor includes a complex programmable logic device.
